(19) United States
(12) Patent Application Publication
(10) Pub. No.: US 2026/0158861 A1
(43) Pub. Date: Jun. 11, 2026

(54) HEAT PUMP SYSTEM FOR A VEHICLE

(71) Applicants: HYUNDAI MOTOR COMPANY, Seoul (KR); KIA CORPORATION, Seoul (KR)

(72) Inventors: Jeawan Kim, Hwaseong-si (KR); Hochan An, Hwaseong-si (KR); Yeon Ho Kim, Hwaseong-si (KR); Hoyoung Jeong, Hwaseong-si (KR); Man Hee Park, Hwaseong-si (KR); Yeong Jun Kim, Hwaseong-si (KR); Jae Yeon Kim, Hwaseong-si (KR); Gwi Taek Kim, Hwaseong-si (KR)

(73) Assignees: HYUNDAI MOTOR COMPANY, Seoul (KR); KIA CORPORATION, Seoul (KR)

(21) Appl. No.: 19/205,494

(22) Filed: May 12, 2025

(30) Foreign Application Priority Data
Dec. 6, 2024 (KR) 10-2024-0181010

(51) Int. Cl. B60H 1/00; F25B 30/02; F25B 41/31

(52) U.S. Cl. CPC B60H 1/00899; B60H 1/00335; F25B 30/02; F25B 41/31

(57) ABSTRACT

A heat pump system for a vehicle may improve the cooling and heating performance by cooling or heating a vehicle interior by using a single heat-exchanger, and employing a gas injection device configured to selectively operate in at least one selected mode for air-conditioning of the vehicle interior to increase the flow rate of the refrigerant. The heat pump system includes a compressor, a control valve, a first heat-exchanger, a first expansion valve, a vehicle interior heat-exchanger, a second expansion valve, a second heat-exchanger, a connection line, a chiller, a third expansion valve, and a gas injection device, where a flow rate of the refrigerant is controlled depending on at least one mode for adjusting a temperature of a vehicle interior or for adjusting a temperature of a heating element.

### CROSS-REFERENCE TO RELATED APPLICATION

This application claims priority to and the benefit of Korean Patent Application No. 10-2024-0181010 filed with the Korean Intellectual Property Office on Dec. 6, 2024, the entire contents of which is incorporated herein by reference.

### BACKGROUND

### Technical Field

The present disclosure relates to a heat pump system for a vehicle, and more particularly, the present disclosure relates to a heat pump system for a vehicle capable of improving the cooling and heating performance by employing a gas injection device that selectively operates in a selected air conditioning mode of the vehicle interior, and cooling or heating the vehicle interior by using a single heat-exchanger.

### Description of the Related Art

An air conditioning system for a vehicle includes an air conditioner unit circulating a refrigerant in order to heat or cool an interior of a vehicle.

The air conditioner unit, which is to maintain the interior of the vehicle at an appropriate temperature regardless of a change in an external temperature to maintain a comfortable interior environment, is configured to heat or cool the interior of the vehicle by heat-exchange by a condenser and an evaporator in a process in which a refrigerant discharged by driving of a compressor is circulated back to the compressor through the condenser, a receiver drier, an expansion valve, and the evaporator.

In other words, the air conditioner unit lowers a temperature and a humidity of the interior by condensing a high-temperature high-pressure gas-phase refrigerant compressed from the compressor by the condenser, passing the refrigerant through the receiver drier and the expansion valve, and then evaporating the refrigerant in the evaporator in a cooling mode in summer.

In accordance with a continuous increase in interest in energy efficiency and an environmental pollution problem, the development of an environment-friendly vehicle capable of substantially substituting for an internal combustion engine vehicle is required, and the environment-friendly vehicle is classified into an electric vehicle driven using a fuel cell or electricity as a power source and a hybrid vehicle driven using an engine and a battery.

In an electric vehicle or a hybrid vehicle among these environment-friendly vehicles, a separate heater is not used, unlike an air conditioner of a general vehicle, and an air conditioner used in an environment-friendly vehicle is called a heat pump system.

An electric vehicle driven by the power source of the fuel cell generates a driving force by converting chemical reaction energy between oxygen and hydrogen into electrical energy. In this process, heat energy is generated by a chemical reaction in a fuel cell. Therefore, it is necessary in securing performance of the fuel cell to effectively remove generated heat.

In addition, a hybrid vehicle generates driving force by driving a motor using electricity supplied from the fuel cell described above or an electrical battery, together with an engine operated by a general fuel, such as gasoline. Therefore, heat generated from the fuel cell or the battery and the motor should be effectively removed in order to secure performance of the motor.

Therefore, in a hybrid vehicle or an electric vehicle according to the related art, a cooling means, a heat pump system, and a battery cooling system should each be configured as separate closed circuits so as to prevent heat generation of the motor, an electric component, and the battery including a fuel cell.

Therefore, a size and a weight of a cooling module disposed at the front of the vehicle are increased, and a layout of connection pipes supplying a refrigerant and a coolant to each of the heat pump system, the cooling means, and the battery cooling system in an engine compartment becomes complicated.

In addition, since a battery cooling system for heating or cooling the battery according to a state of the vehicle is separately provided to obtain an optimal performance of the battery, a plurality of valves for selectively interconnecting connections pipes are employed, and thus noise and vibration due to frequent opening and closing operations of the valves may be introduced into the vehicle interior, thereby deteriorating the ride comfort of the vehicle.

In addition, when heating the vehicle interior, there are disadvantages in that heating performance is reduced due to lack of a heat source, electricity consumption increases due to use of an electric heater, and power consumption of the compressor increases.

In addition, conventional heat pump systems have disadvantages such as increased manufacturing costs and increased overall weight due to an increase in the number of components, since respective heat-exchangers must be provided for cooling or heating the vehicle interior.

The above information disclosed in this Background section is only for enhancement of understanding of the background of the disclosure, and therefore it may contain information that does not form the prior art that is already known in this country to those having ordinary skill in the art.

### SUMMARY

The present disclosure attempts to provide a heat pump system for a vehicle capable of improving the cooling and heating performance by cooling or heating a vehicle interior by using a single heat-exchanger, and employing a gas injection device configured to selectively operate in at least one selected mode for air-conditioning of the vehicle interior to increase the flow rate of the refrigerant.

A heat pump system for a vehicle includes a compressor configured to compress a refrigerant and a control valve connected to the compressor through a refrigerant line. The heat pump system further includes a first heat-exchanger connected to the control valve through the refrigerant line, and configured to selectively condense or evaporate the refrigerant. The heat pump system further includes a first expansion valve connected to the first heat-exchanger through the refrigerant line. The heat pump system further includes a vehicle interior heat-exchanger connected to the first expansion valve and the control valve through the refrigerant line, and configured to selectively condense or evaporate the refrigerant. The heat pump system further includes a second expansion valve provided on the refrigerant line between the first heat-exchanger and the first expansion valve. The heat pump system further includes a second heat-exchanger connected to the refrigerant line connecting the first expansion valve and the second expansion valve, and the refrigerant line connecting the control valve and the compressor at an upstream end of the compressor. The heat pump system further includes a connection line having a first end connected to the refrigerant line at the upstream end of the compressor, and a second end connected to the refrigerant line between the first expansion valve and the second expansion valve. The heat pump system further includes a chiller provided on the connection line, and configured to adjust a temperature of a coolant by heat-exchanging the refrigerant introduced through the connection line with a selectively introduced coolant. The heat pump system further includes a third expansion valve provided on the connection line at an upstream end of the chiller. The heat pump system further includes a gas injection device provided on the refrigerant line between the first expansion valve and the second heat-exchanger, and configured to selectively expand the refrigerant supplied from the second heat-exchanger and allow the expanded refrigerant to flow or allow the expanded refrigerant supplied from the vehicle interior heat-exchanger through the first expansion valve to flow, and to selectively supply a partial refrigerant among the supplied refrigerant to the compressor, to increase a flow rate of the refrigerant circulating through the refrigerant line. The flow rate of the refrigerant is controlled depending on at least one mode of the heat pump system for adjusting a temperature of a vehicle interior or for adjusting a temperature of a heating element.

The gas injection device may include a gas-liquid separator configured to separate the refrigerant into a gaseous refrigerant and a liquid refrigerant and selectively discharge the separated refrigerant. The gas injection device may further include a fourth expansion valve provided on the refrigerant line between the second heat-exchanger and a second end of the connection line. The gas injection device may further include a first line having a first end connected to the fourth expansion valve and a second end connected to the refrigerant line between the fourth expansion valve and the second end of the connection line, and on which the gas-liquid separator is provided. The gas injection device many include a second line having a first end connected to the gas-liquid separator, and a second end connected to the compressor, and a third line having a first end connected to the first expansion valve, and a second end connected to the first line between the fourth expansion valve and the gas-liquid separator.

The gas-liquid separator may be operated when the fourth expansion valve or the first expansion valve may expand the refrigerant and may supply the expanded refrigerant while cooling or the heating the vehicle interior, and configured to supply the gaseous refrigerant among the supplied refrigerant to the compressor through the second line, to increase the flow rate of the refrigerant circulating the refrigerant line.

When heating the vehicle interior, the third line may be opened by the first expansion valve so the refrigerant supplied from the vehicle interior heat-exchanger is introduced.

The at least one mode may include a first mode for cooling the vehicle interior and in which the gas injection device is operated, a second mode for recollecting an ambient air heat while heating the vehicle interior, and in which the gas injection device is operated, a third mode for recollecting a waste heat of the heating element while heating the vehicle interior and in which the gas injection device is operated, and a fourth mode for recollecting the ambient air heat and the waste heat of the heating element while heating the vehicle interior, and in which the gas injection device is operated.

In the first mode, a portion of the refrigerant line connecting the compressor, the first heat-exchanger, the second heat-exchanger, and the fourth expansion valve may be opened by the control valve and the second expansion valve. A portion of the refrigerant line connecting the fourth expansion valve and a second end of the first line may be closed by the fourth expansion valve. A portion of the refrigerant line connecting the second end of the first line to the first expansion valve, the vehicle interior heat-exchanger, and the control valve may be opened by the first expansion valve. A portion of the refrigerant line connecting the control valve to the upstream end of the compressor may be opened by the control valve. The first line may be opened by the fourth expansion valve, the second line may be opened, and the third line may be closed by the first expansion valve. The first expansion valve may expand the refrigerant introduced from the gas-liquid separator through the first line and the refrigerant line and may supply the expanded refrigerant to the vehicle interior heat-exchanger. The second expansion valve may allow the refrigerant introduced through the refrigerant line from the first heat-exchanger to flow to the second heat-exchanger without expansion. The fourth expansion valve may expand the refrigerant supplied from the second heat-exchanger through the refrigerant line and may supply the expanded refrigerant to the gas-liquid separator through the first line. The gas-liquid separator may supply the gaseous refrigerant among the supplied refrigerant to the compressor through the opened second line and discharge the liquid refrigerant to the first expansion valve through the first line and the refrigerant line.

The control valve may be configured to allow the refrigerant introduced through the refrigerant line from the compressor to flow along the refrigerant line connected to the first heat-exchanger and allow the refrigerant introduced through the refrigerant line from the vehicle interior heat-exchanger to flow along the refrigerant line connected to the upstream end of the compressor.

When cooling of the heating element is required in the first mode, the connection line may be opened by the third expansion valve, and the third expansion valve may expand the refrigerant introduced through the connection line and may supply the expanded refrigerant to the chiller.

In the second mode, a portion of the refrigerant line connecting the compressor, the vehicle interior heat-exchanger, and the first expansion valve may be opened by the control valve. A portion of the refrigerant line connecting the first expansion valve to a second end of the first line may be closed by the first expansion valve. A portion of the refrigerant line connecting the second end of the first line to the fourth expansion valve may be opened by the fourth expansion valve. A portion of the refrigerant line connecting the fourth expansion valve to the second heat-exchanger, the second expansion valve, the first heat-exchanger, and the control valve may be opened by the control valve and the second expansion valve. A portion of the refrigerant line connecting the control valve to the upstream end of the compressor may be opened by the control valve. The connection line may be closed by the third expansion valve. A portion of the first line connecting the fourth expansion valve to a second end of the third line may be closed by the fourth expansion valve. A portion of the first line connecting the second end of the third line to the gas-liquid separator, and a remaining first line connecting the second end of the first line to the gas-liquid separator may be opened. The second line may be opened, and the third line may be opened by the first expansion valve. The first expansion valve may expand the refrigerant introduced through the refrigerant line from the vehicle interior heat-exchanger and may allow the expanded refrigerant to flow along the third line. The second expansion valve may allow the refrigerant introduced through the refrigerant line from the second heat-exchanger to flow to the first heat-exchanger without expansion. The third expansion valve may stop operating. The fourth expansion valve may expand the refrigerant supplied from the gas-liquid separator through the opened portion of the first line and the refrigerant line and may supply the expanded refrigerant to the second heat-exchanger through the refrigerant line The gas-liquid separator may supply the gaseous refrigerant among the supplied refrigerant to the compressor through the opened second line and discharge the liquid refrigerant to the fourth expansion valve through a portion of the first line and the refrigerant line.

The control valve may be configured to allow the refrigerant introduced through the refrigerant line from the compressor to flow along the refrigerant line connected to the vehicle interior heat-exchanger and allow the refrigerant introduced through the refrigerant line from the first heat-exchanger to flow along the refrigerant line connected to the upstream end of the compressor.

In the third mode, a portion of the refrigerant line connecting the compressor, the vehicle interior heat-exchanger, and the first expansion valve may be opened by the control valve. A portion of the refrigerant line connecting the first expansion valve to the second end of the connection line may be closed by the first expansion valve. A portion of the refrigerant line connecting the control valve to a second end of the first line via the first heat-exchanger, the second expansion valve, the second heat-exchanger, and the fourth expansion valve may be closed by the control valve. A portion of the refrigerant line connecting the control valve to the upstream end of the compressor may be closed by the control valve. A portion of the refrigerant line connecting the second end of the first line to the second end of the connection line may be opened. The connection line may be opened by the third expansion valve. A portion of the first line connecting the fourth expansion valve to a second end of the third line may be closed by the fourth expansion valve. A portion of the first line connecting the second end of the third line to the gas-liquid separator, and a remaining first line connecting the second end of the first line to the gas-liquid separator may be opened. The second line may be opened, and the third line may be opened by the first expansion valve. The first expansion valve may expand the refrigerant introduced through the refrigerant line from the vehicle interior heat-exchanger and may allow the expanded refrigerant to flow along the third line. The second expansion valve and the fourth expansion valve stop operating. The third expansion valve may expand the refrigerant introduced through the connection line and may supply the expanded refrigerant to the chiller. The gas-liquid separator may supply the gaseous refrigerant among the supplied refrigerant to the compressor through the opened second line and discharge the liquid refrigerant to the third expansion valve through a portion of the first line, a portion of the refrigerant line, and the connection line.

The control valve may be configured to allow the refrigerant introduced through the refrigerant line from the compressor to flow along the refrigerant line connected to the vehicle interior heat-exchanger.

In the fourth mode, a portion of the refrigerant line connecting the compressor, the vehicle interior heat-exchanger, and the first expansion valve may be opened by the control valve. A portion of the refrigerant line connecting the first expansion valve to the second end of the connection line may be closed by the first expansion valve. A portion of the refrigerant line connecting a second end of the first line to the fourth expansion valve may be opened by the fourth expansion valve. A portion of the refrigerant line connecting the fourth expansion valve to the second heat-exchanger, the second expansion valve, the first heat-exchanger, and the control valve may be opened by the control valve and the second expansion valve. A portion of the refrigerant line connecting the second end of a first line to the second end of the connection line may be opened. A portion of the refrigerant line connecting the control valve to the upstream end of the compressor may be opened by the control valve. A portion of the refrigerant line connecting the second end of the first line to the second end of the connection line may be opened. The connection line may be opened by the third expansion valve. A portion of the first line connecting the fourth expansion valve to a second end of the third line may be closed by the fourth expansion valve. A portion of the first line connecting the second end of the third line to the gas-liquid separator, and a remaining first line connecting the second end of the first line to the gas-liquid separator may be opened. The second line may be opened, and the third line may be opened by the first expansion valve. The first expansion valve may expand the refrigerant introduced through the refrigerant line from the vehicle interior heat-exchanger and may allow the expanded refrigerant to flow along the third line. The second expansion valve may allow the refrigerant introduced through the refrigerant line from the second heat-exchanger to flow to the first heat-exchanger without expansion. The third expansion valve may expand the refrigerant introduced through the connection line and may supply the expanded refrigerant to the chiller. The fourth expansion valve may expand the refrigerant supplied from the gas-liquid separator through the opened portion of the first line and the refrigerant line, and may supply the expanded refrigerant to the second heat-exchanger through the refrigerant line. The gas-liquid separator may supply the gaseous refrigerant among the supplied refrigerant to the compressor through the opened second line, and discharge the liquid refrigerant to the third expansion valve and the fourth expansion valve, through a portion of the first line, a portion of the refrigerant line, and the connection line.

The control valve may be configured to allow the refrigerant introduced through the refrigerant line from the compressor to flow along the refrigerant line connected to the vehicle interior heat-exchanger, and allow the refrigerant introduced through the refrigerant line from the first heat-exchanger to flow along the refrigerant line connected to the upstream end of the compressor.

The first heat-exchanger may be configured to condense the refrigerant supplied in the first mode, and evaporate the refrigerant supplied in the second mode and the fourth mode.

The vehicle interior heat-exchanger may be configured to evaporate the refrigerant supplied in the first mode, and condense the refrigerant supplied in the second mode, the third mode, and the fourth mode.

The first expansion valve and the fourth expansion valve may be 3-way electronic expansion valves selectively operated in the at least one mode and configured to selectively expand the refrigerant while controlling the flow rate of the supplied refrigerant. The second expansion valve and the third expansion valve may be 2-way electronic expansion valves selectively operated in the at least one mode and configured to selectively expand the refrigerant while controlling the flow rate of the supplied refrigerant.

The first heat-exchanger and the vehicle interior heat-exchanger may be configured to selectively condense or evaporate the refrigerant introduced in the at least one mode.

The second heat-exchanger may be configured to heat-exchange the refrigerant introduced from at least one of the first heat-exchanger or the gas injection device, and the refrigerant introduced from at least one of the first heat-exchanger or the vehicle interior heat-exchanger or the chiller, with each other.

The chiller may be connected to the heating element through a coolant line circulating a coolant, and the coolant line may be opened to connect the heating element and the chiller, when cooling of the heating element is required, or when the waste heat is to be recollected from the heating element.

As described above, according to a heat pump system for a vehicle according to an embodiment, the number of components may be reduced by cooling or heating the vehicle interior by using a single heat-exchanger into which a high-temperature refrigerant or a low-temperature refrigerant is selectively introduced.

In addition, according to the present disclosure, by employing a gas injection device configured to selectively operate in at least one selected mode for air-conditioning of the vehicle interior to increase the flow rate of the refrigerant, the cooling and heating performance may be improved.

In addition, according to the present disclosure, the performance of the system by using the gas injection device may be maximized while minimizing the required components, and accordingly, streamlining and simplification of the system may be achieved.

In addition, according to the present disclosure, through streamlining of an entire system, it is possible to reduce manufacturing cost and weight and improve space utilization of a vehicle or a system for the vehicle.

### BRIEF DESCRIPTION OF THE DRAWINGS

FIG. 1 is a block diagram of a heat pump system for a vehicle according to an embodiment.

FIG. 2 is an operation diagram according to a first mode of a heat pump system for a vehicle according to an embodiment.

FIG. 3 is an operation diagram according to a second mode of a heat pump system for a vehicle according to an embodiment.

FIG. 4 is an operation diagram according to a third mode of a heat pump system for a vehicle according to an embodiment.

FIG. 5 is an operation diagram according to a fourth mode of a heat pump system for a vehicle according to an embodiment.

### DETAILED DESCRIPTION

Embodiments of the present disclosure are hereinafter described in detail with reference to the accompanying drawings.

Embodiments disclosed in the present specification and the constructions depicted in the drawings are only example embodiments of the present disclosure, and do not cover the entire scope of the present disclosure. Therefore, it should be understood that there may be various equivalents to and variations of the disclosed embodiments at a time that the technical concepts of this specification are applied.

In order to clarify the present disclosure, parts that are not related to the description may have been omitted. Further, the same elements or equivalents are referred to with the same reference numerals throughout the specification.

Also, the size and thickness of each element may be arbitrarily shown in the drawings, but the present disclosure is not necessarily limited thereto. In the drawings, the thickness of layers, films, panels, regions, and the like, may be exaggerated for clarity.

In addition, unless explicitly described to the contrary, the words “comprise”, “have”, “include” and variations thereof such as “comprises” or “comprising”, should be understood to imply the inclusion of stated elements but not the exclusion of any other elements.

Furthermore, each of terms, such as “ . . . unit”, “ . . . means”, “ . . . portions”, “ . . . part”, and “ . . . member” described in the specification, mean a unit of a comprehensive element that performs at least one function or operation. When a component, device, unit, module, controller, detector, element, or the like of the present disclosure is described as having a purpose or performing an operation, function, or the like, the component, device, unit, module, controller, detector, or element should be considered herein as being “configured to” meet that purpose or to perform that operation or function. The present disclosure describes a controller and a data detector for a cooling system. The controller, detector, or other such components may separately embody or be included with a processor and a memory, such as a non-transitory computer readable media, as part of the controller or component.

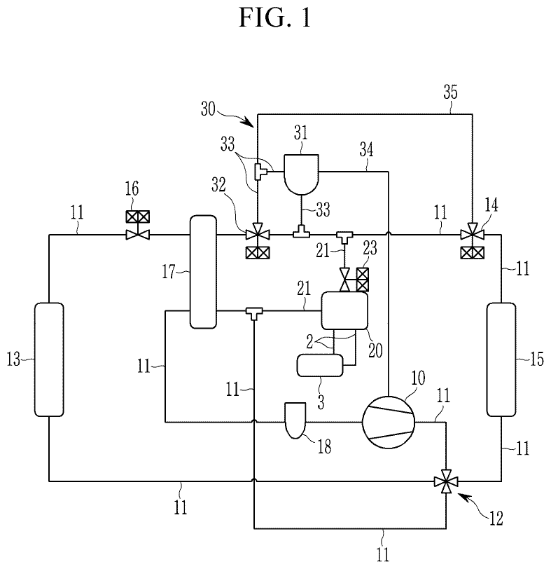

FIG. 1 is a block diagram of a heat pump system for a vehicle according to an embodiment of the present disclosure.

According to a heat pump system for a vehicle according to an embodiment of the present disclosure, by cooling or heating the vehicle interior by using a single vehicle interior heat-exchanger 15 into which a high-temperature refrigerant or a low-temperature refrigerant is selectively introduced, the number of system components may be reduced. By employing a gas injection device 30, selectively operating the heat pump system in at least one mode selected for air-conditioning of the vehicle interior to increase the flow rate of the refrigerant, the cooling and heating performance of the system may be improved.

The heat pump system may efficiently adjust the temperature of a heating element 3 by using a single chiller 20 where the refrigerant and a coolant are heat-exchanged with each other. In addition, when heating the vehicle interior, the heat pump system may selectively use ambient air heat, and the waste heat of the heating element 3.

The heating element 3 may include a motor, an electrical component, a battery module, and/or the like. The electrical component may include an electrical power control unit (EPCU), a motor, an inverter, an on-board charger (OBC), or an autonomous driving controller, or the like.

The heating element 3 configured as such may be connected to the chiller 20 through a coolant line 2 through which the coolant circulates.

When cooling of the heating element 3 is required, or when the waste heat from the heating element 3 is to be recollected, the coolant line 2 may be opened to connect the heating element 3 and the chiller 20. The coolant may selectively circulate through the coolant line 2 by an operation of a water pump (not shown) to impart flow of the coolant through the coolant line 2.

Referring to FIG. 1, a heat pump system according to an embodiment of the present disclosure may include a compressor 10, a control valve 12, a first heat-exchanger 13, a first expansion valve 14, the vehicle interior heat-exchanger 15, a second expansion valve 16, a second heat-exchanger 17, the chiller 20, a connection line 21, a third expansion valve 23, and the gas injection device 30.

In the disclosed system, the compressor 10 may compress the supplied refrigerant.

The control valve 12 may be connected to the compressor 10 through a refrigerant line 11. The control valve 12 may control a flow direction of the refrigerant introduced through the refrigerant line 11 from the compressor 10.

The control valve 12 may be a 4-way valve capable of distributing the flow rate while controlling the flow of the refrigerant.

In an embodiment, the first heat-exchanger 13 may be connected to the control valve 12 through the refrigerant line 11. The first heat-exchanger 13 may be disposed at an upstream end, i.e., the front of the vehicle (relative to the normal driving or movement direction).

Accordingly, in the at least one mode of the heat pump system, the first heat-exchanger 13 may condense or evaporate the introduced refrigerant through heat-exchange with the ambient air introduced during driving of the vehicle.

In other words, the first heat-exchanger 13 may be an air-cooled heat-exchanger configured to heat-exchange the introduced refrigerant with the ambient air.

The first expansion valve 14 may be connected to the first heat-exchanger 13 through the refrigerant line 11. The first expansion valve 14 may selectively expand the introduced refrigerant.

The first expansion valve 14 configured as such may be a 3-way electronic expansion valve selectively operated in the at least one mode of the heat pump system and configured to selectively expand the refrigerant while controlling the flow of the supplied refrigerant.

The vehicle interior heat-exchanger 15 may be respectively connected to the first expansion valve 14 and the control valve 12 through the refrigerant line 11. The vehicle interior heat-exchanger 15 may be provided inside an HVAC module (not shown).

Accordingly, when cooling the vehicle interior, the vehicle interior heat-exchanger 15 may evaporate the refrigerant through heat-exchange with the ambient air introduced into the HVAC module. The ambient air may be cooled while passing through the vehicle interior heat-exchanger 15.

The ambient air introduced into the HVAC module may be converted into a low-temperature state while passing through the vehicle interior heat-exchanger 15 and introduced into the vehicle interior, thereby achieving cooling of the vehicle interior.

To the contrary, when heating the vehicle interior, the vehicle interior heat-exchanger 15 may condense the refrigerant through heat-exchange with the ambient air introduced into the HVAC module. The ambient air may increase its temperature while passing through the vehicle interior heat-exchanger 15.

The ambient air introduced into the HVAC module may be converted into a high-temperature state while passing through the vehicle interior heat-exchanger 15 and then introduced into the vehicle interior, thereby implementing heating of the vehicle interior.

In other words, in the at least one mode of the heat pump system, the vehicle interior heat-exchanger 15 may selectively condense or evaporate the introduced refrigerant through heat-exchange with the ambient air.

Accordingly, the heat pump system may perform cooling or heating of the vehicle interior by using the single vehicle interior heat-exchanger 15.

In an embodiment, the second expansion valve 16 may be provided on, i.e., connected to or along, the refrigerant line 11 between the first heat-exchanger 13 and the first expansion valve 14.

When cooling the vehicle interior, the second expansion valve 16 may allow the introduced refrigerant to flow without expansion.

To the contrary, when heating the vehicle interior, the second expansion valve 16 may expand the introduced refrigerant, and may allow the expanded refrigerant to flow.

The second expansion valve 16 configured as such may be a 2-way electronic expansion valve selectively operated in the at least one mode of the heat pump system and configured to selectively expand the refrigerant while controlling the flow of the supplied refrigerant.

The second heat-exchanger 17 may be respectively connected to the refrigerant line 11 connecting the first expansion valve 14 and the second expansion valve 16, and the refrigerant line 11 connecting the control valve 12 and the compressor 10 at an upstream end of the compressor 10, based on the flow of the refrigerant.

Depending on the at least one mode of the heat pump system, the second heat-exchanger 17 may heat-exchange the refrigerant introduced from at least one of the first heat-exchanger 13 or the gas injection device 30, and the refrigerant introduced from at least one of the first heat-exchanger 13, the vehicle interior heat-exchanger 15, or the chiller 20, with each other.

In an embodiment, the upstream end of the compressor 10 may be set based on the flow direction of the refrigerant.

Based on the direction in which the refrigerant flows along the refrigerant line 11, the location where the refrigerant is introduced into the compressor 10 may be defined as an upstream end of the compressor 10, and the location where the refrigerant is discharged from the compressor 10 may be defined as a downstream end of the compressor 10.

The heat pump system may further include an accumulator 18. The accumulator 18 may be provided on, i.e., connected to or along, the refrigerant line 11 at the upstream end of the compressor 10.

The accumulator 18 may supply only the gaseous refrigerant to the compressor 10, thereby improving the efficiency and durability of the compressor 10.

In an embodiment, the chiller 20 may be connected to the refrigerant line 11 through the connection line 21. In other words, the chiller 20 may be provided on, i.e., connected to or along, the connection line 21.

The chiller 20 may be connected to the heating element 3 through the coolant line 2. Accordingly, the coolant may selectively circulate through the chiller 20.

The chiller 20 configured as such may adjust a temperature of the coolant by heat-exchanging the refrigerant introduced through the connection line 21 with the coolant supplied from the heating element 3.

In more detail, the chiller 20 may adjust the temperature of the coolant by heat-exchanging the supplied refrigerant with the coolant. The chiller 20 may be a water-cooled heat-exchanger configured to heat-exchange the interiorly introduced refrigerant with the coolant.

A first end of the connection line 21 may be connected to the refrigerant line 11 at the upstream end of the compressor 10. In addition, a second end of the connection line 21 may be connected to the refrigerant line 11 between the first expansion valve 14 and the second expansion valve 16.

In other words, the chiller 20 may adjust the temperature of the coolant by heat-exchanging the coolant selectively introduced through the coolant line 2 with the selectively supplied refrigerant. The coolant heat-exchanged in the chiller 20 may circulate through the heating element 3 through the coolant line 2.

A water pump (not shown) may be provided on the coolant line 2. In other words, the coolant may circulate along the coolant line 2 according to the operation of a water pump (not shown).

Accordingly, the coolant heat-exchanged with the refrigerant in the chiller 20 may be selectively supplied to the heating element 3, to adjust the temperature of the electrical component and the battery module included in the heating element 3.

In other words, when cooling or heating of the vehicle interior is required, the coolant may circulate along the coolant line 2 so that the coolant having passed through the heating element 3 is supplied to the chiller 20.

The chiller 20 may recollect the waste heat of the heating element 3 while heat-exchanging the coolant introduced through the coolant line 2 with the refrigerant, or may cool the heating element 3 by using the coolant heat-exchanged with the refrigerant.

The third expansion valve 23 may be provided on the connection line 21 at an upstream end of the chiller 20, based on the flow direction of the refrigerant.

When cooling the heating element 3 by using the coolant heat-exchanged with the refrigerant, the third expansion valve 23 may expand the refrigerant introduced through the connection line 21 and allow the expanded refrigerant to flow into the chiller 20.

In other words, when cooling of the heating element 3 is required, the third expansion valve 23 may expand the refrigerant introduced through the connection line 21 to lower its temperature and allow the expanded refrigerant to flow into chiller 20, and thereby may further lower the temperature of the coolant passing through the interior of the chiller 20.

Accordingly, the coolant having its temperature decreased while passing through the chiller 20 may be introduced into the heating element 3, thereby achieving more efficient cooling.

The third expansion valve 23 may be a 2-way electronic expansion valve selectively operated in the at least one mode of the heat pump system for adjusting a temperature of a vehicle interior or for adjusting a temperature of the heating element 3 and configured to selectively expand the refrigerant while controlling the flow of the supplied refrigerant.

The third expansion valve 23 may be disposed at the upstream end of the chiller 20, based on the flow direction of the refrigerant flowing along the connection line 21 to the chiller 20.

In other words, the upstream end of the chiller 20 may be set based on the flow direction of the refrigerant.

Based on the direction in which the refrigerant flows along the connection line 21, the location where the refrigerant is introduced into the chiller 20 may be defined as an upstream end of the chiller 20, and the location where the refrigerant is discharged from the chiller 20 may be defined as a downstream end of the chiller 20.

In addition, the gas injection device 30 may be provided on, i.e., connected to or along, the refrigerant line 11 between the first expansion valve 14 and the second heat-exchanger 17.

The gas injection device 30 may selectively expand the refrigerant supplied from the second heat-exchanger 17 and allow the expanded refrigerant to flow, or may allow the expanded refrigerant supplied from the vehicle interior heat-exchanger 15 through the first expansion valve 14 to flow.

In addition, the gas injection device 30 may selectively supply a partial refrigerant among the supplied refrigerant to the compressor 10, to increase the flow rate of the refrigerant circulating within or through the refrigerant line 11.

The gas injection device 30 configured as such may be selectively operated at the time of cooling or heating the vehicle interior.

The gas injection device 30 may include a gas-liquid separator 31, a fourth expansion valve 32, a first line 33, a second line 34, and a third line 35.

The gas-liquid separator 31 may separate the interiorly introduced refrigerant into a gaseous refrigerant and a liquid refrigerant and selectively discharge the separated refrigerant.

The fourth expansion valve 32 may be provided on the refrigerant line 11 between the second heat-exchanger 17 and the second end of the connection line 21.

When an operation of the gas injection device 30 is required, the fourth expansion valve 32 may expand the refrigerant supplied from the second heat-exchanger 17, and may supply the expanded refrigerant to the gas-liquid separator 31 through the first line 33.

The fourth expansion valve 32 configured as such may be a 3-way electronic expansion valve selectively operated in the at least one mode of the heat pump system and configured to selectively expand the refrigerant while controlling the flow of the supplied refrigerant.

In an embodiment, a first end of the first line 33 may be connected to the fourth expansion valve 32. A second end of the first line 33 may be connected to the refrigerant line 11 between the fourth expansion valve 32 and the second end of the connection line 21.

The gas-liquid separator 31 configured as such may be provided on, i.e., connected to or along, the first line 33.

In other words, the first line 33 may selectively supply the refrigerant supplied from the second heat-exchanger 17 to the gas-liquid separator 31 according to an operation of the fourth expansion valve 32.

In addition, the first line 33 may allow the refrigerant discharged from the gas-liquid separator 31 to flow along the refrigerant line 11.

In an embodiment, a first end of the second line 34 may be connected to the gas-liquid separator 31. A second end of the second line 34 may be connected to the compressor 10.

When the expanded refrigerant is supplied to the gas-liquid separator 31, the second line 34 may supply the gaseous refrigerant discharged from the gas-liquid separator 31 to the compressor 10.

In other words, the second line 34 may connect the gas-liquid separator 31 and the compressor 10 so that the gaseous refrigerant separated at the gas-liquid separator 31 is selectively introduced into the compressor 10.

In addition, a first end of the third line 35 may be connected to the first expansion valve 14. A second end of the third line 35 may be connected to the first line 33 between the fourth expansion valve 32 and the gas-liquid separator 31.

When heating the vehicle interior, the third line 35 may be opened by the first expansion valve 14, so that the refrigerant supplied from the vehicle interior heat-exchanger 15 is introduced.

The first expansion valve 14 may expand the refrigerant supplied from the vehicle interior heat-exchanger 15, and may allow the expanded refrigerant to flow along the third line 35.

In the gas injection device 30 configured as such, in the at least one mode of the heat pump system, the gas-liquid separator 31 may be operated when the first expansion valve 14, or the fourth expansion valve 32 expands the refrigerant.

When the first expansion valve 14 or the fourth expansion valve 32 expands the refrigerant and supplies the expanded refrigerant to the gas-liquid separator 31, the gas-liquid separator 31 may supply the gaseous refrigerant among the supplied refrigerant to the compressor 10 through the second line 34, to increase the flow rate of the refrigerant circulating in or through the refrigerant line 11.

In the heat pump system configured as such, the flow of the refrigerant may be controlled depending on the at least one mode for adjusting the temperature of the vehicle interior or for adjusting the temperature of the heating element 3.

In other words, in the at least one mode of the heat pump system, the control valve 12, the first expansion valve 14, the second expansion valve 16, the third expansion valve 23, and the fourth expansion valve 32 may be selectively operated.

The at least one mode of the heat pump system may include a first mode to a fourth mode.

In the first mode, the gas injection device 30 may be operated, and the vehicle interior may be cooled.

In the second mode, the gas injection device 30 may be operated, and the ambient air heat may be recollected while heating the vehicle interior.

In the third mode, the gas injection device 30 may be operated, and the waste heat of the heating element 3 may be recollected while heating the vehicle interior.

In addition, in the fourth mode, the gas injection device 30 may be operated, and the ambient air heat and the waste heat of the heating element 3 may be recollected while heating the vehicle interior.

In the first mode, the first heat-exchanger 13 may condense the supplied refrigerant through heat-exchange with the ambient air. To the contrary, the first heat-exchanger 13 may evaporate the refrigerant supplied in the second mode and the fourth mode through heat-exchange with the ambient air.

In addition, in the first mode, the vehicle interior heat-exchanger 15 may evaporate the supplied refrigerant through heat-exchange with the ambient air introduced into an HVAC module (not shown).

On the other hand, in the second mode, the third mode, and the fourth mode, the vehicle interior heat-exchanger 15 may condense the supplied refrigerant through heat-exchange with the ambient air introduced into the HVAC module (not shown).

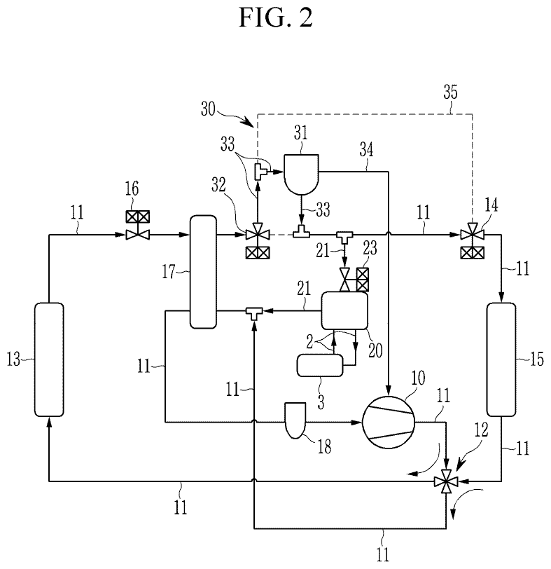

An operation and action for each mode of a heat pump system according to an embodiment configured as such are described in detail with reference to FIGS. 2-5.

In a heat pump system according to an embodiment of the present disclosure, an operation in the first mode for cooling the vehicle interior and in which the gas injection device 30 is operated is described in detail below with reference to FIG. 2.

FIG. 2 is an operation diagram according to the first mode in a heat pump system for the vehicle according to an embodiment of the present disclosure.

Referring to FIG. 2, in the first mode, in order to cool the vehicle interior, the compressor 10 may be operated so that the refrigerant flows along the refrigerant line 11.

The compressor 10, a portion of the refrigerant line 11 connecting the first heat-exchanger 13, the second heat-exchanger 17, and the fourth expansion valve 32 may be opened by the control valve 12 and the second expansion valve 16.

In addition, the portion of the refrigerant line 11 connecting the fourth expansion valve 32 and the second end of the first line 33 may be closed by the fourth expansion valve 32.

In addition, the portion of the refrigerant line 11 connecting the second end of the first line 33 to the first expansion valve 14, the vehicle interior heat-exchanger 15, and the control valve 12 may be opened by the first expansion valve 14.

In addition, the portion of the refrigerant line 11 connecting the control valve 12 to the upstream end of the compressor 10 may be opened by the control valve 12.

The first line 33 may be opened by the fourth expansion valve 32. The second line 34 may be opened. In addition, the third line 35 may be closed by the first expansion valve 14.

Thus, the refrigerant discharged from the compressor 10 may be introduced into the control valve 12 along the refrigerant line 11.

The control valve 12 may allow the refrigerant introduced through the refrigerant line 11 from the compressor 10 to flow along the refrigerant line 11 connected to the first heat-exchanger 13.

Accordingly, the refrigerant supplied to the first heat-exchanger 13 may be condensed through heat-exchange with the ambient air. The refrigerant condensed in the first heat-exchanger 13 may be introduced into the second expansion valve 16 along the refrigerant line 11.

The second expansion valve 16 may allow the refrigerant introduced through the refrigerant line 11 from the first heat-exchanger 13 to flow to the second heat-exchanger 17 without expansion.

The refrigerant having passed through the second heat-exchanger 17 may be introduced into the fourth expansion valve 32. The fourth expansion valve 32 may expand the refrigerant supplied from the second heat-exchanger 17 through the refrigerant line 11 and supply the expanded refrigerant to the gas-liquid separator 31 through the first line 33.

The gas-liquid separator 31 may supply the gaseous refrigerant among the refrigerant supplied from the fourth expansion valve 32 through the first line 33 to the compressor 10 through the opened second line 34.

In other words, the gas injection device 30 may allow the gaseous refrigerant separated while passing through the gas-liquid separator 31 to flow back to the compressor 10 through the second line 34, to increase the flow rate of the refrigerant circulating the refrigerant line 11.

The gas-liquid separator 31 may discharge the liquid refrigerant among the refrigerant supplied through the first line 33 to the refrigerant line 11 connected to the first expansion valve 14 through the first line 33.

When cooling of the battery module included in the heating element 3 is required, the connection line 21 may be opened by the third expansion valve 23.

Accordingly, a partial refrigerant among the refrigerant flowing along the refrigerant line 11 from the first line 33 may be introduced into the opened connection line 21, and a remaining refrigerant may be introduced into the first expansion valve 14.

The third expansion valve 23 may expand the refrigerant introduced through the connection line 21 and supply the expanded refrigerant to the chiller 20.

The refrigerant introduced into the chiller 20 may cool the coolant while being heat-exchanged with the coolant supplied from the heating element 3 through the coolant line 2.

The coolant cooled in the chiller 20 may be supplied to the heating element 3 along the coolant line 2. Accordingly, the battery module included in the heating element 3 may be efficiently cooled by the coolant cooled in the chiller 20.

In other words, the coolant circulating through the coolant line 2 may efficiently cool the heating element 3 while repeatedly performing the above-described operation.

The first expansion valve 14 may expand the refrigerant introduced through the refrigerant line 11 and supply the expanded refrigerant to the vehicle interior heat-exchanger 15.

The ambient air introduced into the HVAC module may be cooled by the low-temperature refrigerant introduced into the vehicle interior heat-exchanger 15 while passing through the vehicle interior heat-exchanger 15. The cooled ambient air may cool the vehicle interior by being directly introduced into the vehicle interior.

The refrigerant having passed through the vehicle interior heat-exchanger 15 may be introduced into the control valve 12 along the refrigerant line 11.

The control valve 12 may allow the refrigerant introduced through the refrigerant line 11 from the vehicle interior heat-exchanger 15 to flow along the refrigerant line 11 connected to the upstream end of the compressor 10.

Accordingly, the refrigerant discharged from the vehicle interior heat-exchanger 15 may be introduced into the second heat-exchanger 17 along the refrigerant line 11 by the control valve 12.

In addition, the refrigerant having passed through the chiller 20 may be introduced into the second heat-exchanger 17 together with the refrigerant discharged from the vehicle interior heat-exchanger 15.

The second heat-exchanger 17 may heat-exchange the refrigerant introduced from the vehicle interior heat-exchanger 15 and the chiller 20 with the refrigerant introduced from the first heat-exchanger 13.

Accordingly, the second heat-exchanger 17 may further lower the temperature of the refrigerant discharged to the fourth expansion valve 32, and may increase the condensation degree.

The refrigerant having passed through the second heat-exchanger 17 from the vehicle interior heat-exchanger 15 and the chiller 20 along the refrigerant line 11 may be introduced into the accumulator 18. Thereafter, the refrigerant may pass through the accumulator 18, to be introduced into the compressor 10.

In other words, the refrigerant having passed through the second heat-exchanger 17 from the vehicle interior heat-exchanger 15 and the chiller 20, and the refrigerant supplied from the gas-liquid separator 31 through the second line 34 may be introduced into the compressor 10. The introduced refrigerant may be compressed by an operation of the compressor 10.

The refrigerant compressed in the compressor 10 may sequentially pass through the first heat-exchanger 13 and the second expansion valve 16 along the refrigerant line 11 connected by the control valve 12, to be supplied to the fourth expansion valve 32.

Then, the heat pump system may repeatedly perform the above-described processes.

In other words, while repeatedly performing the above-described operation, the heat pump system may increase the flow rate of the refrigerant flowing along the refrigerant line 11.

In addition, the heat pump system may increase the flow rate of the refrigerant flowing along the refrigerant line 11, thereby improving the overall cooling performance and efficiency, and efficiently cooling the vehicle interior.

Simultaneously, the heat pump system may efficiently cool the battery module included in the heating element 3 by using a low-temperature coolant cooled in the chiller 20.

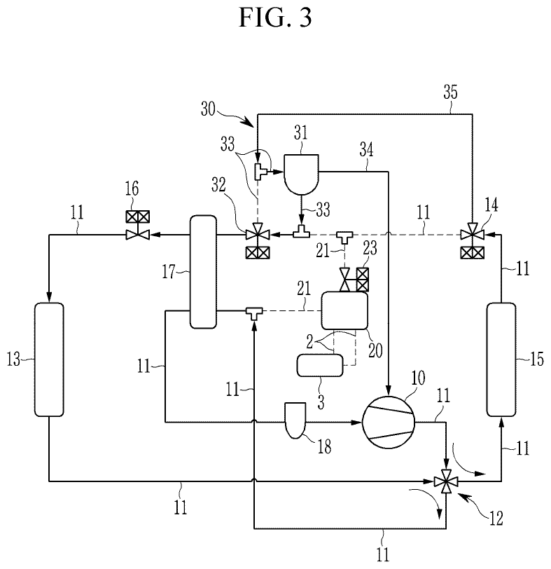

In an embodiment of the present disclosure, an operation in the second mode for recollecting the ambient air heat while heating the vehicle interior and in which the gas injection device 30 is operated is described in detail below with reference to FIG. 3.

FIG. 3 is an operation diagram according to the second mode in a heat pump system for the vehicle according to an embodiment of the present disclosure.

Referring to FIG. 3, in the second mode, in order to heat the vehicle interior, the compressor 10 may be operated so that the refrigerant flows along the refrigerant line 11.

The portion of the refrigerant line 11 connecting the compressor 10, the vehicle interior heat-exchanger 15, and the first expansion valve 14 may be opened by the control valve 12.

In addition, the portion of the refrigerant line 11 connecting the first expansion valve 14 to the second end of the first line 33 may be closed by the first expansion valve 14.

In addition, the portion of the refrigerant line 11 connecting the second end of the first line 33 to the fourth expansion valve 32 may be opened by the fourth expansion valve 32.

The portion of the refrigerant line 11 connecting the fourth expansion valve 32 to the second heat-exchanger 17, the second expansion valve 16, the first heat-exchanger 13, and the control valve 12 may be opened by the control valve 12 and the second expansion valve 16.

In addition, the portion of the refrigerant line 11 connecting the control valve 12 to the upstream end of the compressor 10 may be opened by the control valve 12.

The connection line 21 may be closed by the third expansion valve 23. The operation of the third expansion valve 23 may be stopped.

A portion of the first line 33 connecting the fourth expansion valve 32 to the second end of the third line 35 may be closed by the fourth expansion valve 32.

In addition, a portion of the first line 33 connecting the second end of the third line 35 to the gas-liquid separator 31, and a remaining first line 33 connecting the second end of the first line 33 to the gas-liquid separator 31 may be opened.

The second line 34 may be opened. In addition, the third line 35 may be opened by the first expansion valve 14.

Thus, the refrigerant discharged from the compressor 10 may be introduced into the control valve 12 along the refrigerant line 11.

The control valve 12 may allow the refrigerant introduced through the refrigerant line 11 from the compressor 10 to flow along the refrigerant line 11 connected to the vehicle interior heat-exchanger 15.

In other words, the refrigerant compressed in the compressor 10 may be supplied to the vehicle interior heat-exchanger 15 along the refrigerant line 11 connected by the control valve 12.

The vehicle interior heat-exchanger 15 may condense the introduced refrigerant through heat-exchange with the ambient air introduced into the HVAC module. The refrigerant supplied to the vehicle interior heat-exchanger 15 may increase the temperature of the ambient air introduced into the HVAC module.

Accordingly, the ambient air introduced from the outside may be converted into a high-temperature state while passing through the vehicle interior heat-exchanger 15 and then introduced into the vehicle interior, thereby implementing heating of the vehicle interior.

The refrigerant condensed in the vehicle interior heat-exchanger 15 may be introduced into the first expansion valve 14 along the refrigerant line 11.

The first expansion valve 14 may expand the refrigerant introduced through the refrigerant line 11 from the vehicle interior heat-exchanger 15, and may allow the expanded refrigerant to flow along the third line 35.

The refrigerant flowing through the third line 35 may be introduced into the gas-liquid separator 31 along the opened portion of the first line 33.

The gas-liquid separator 31 may supply the gaseous refrigerant among the refrigerant supplied from the first expansion valve 14 through the third line 35 and a portion of the first line 33 to the compressor 10 through the opened second line 34.

In other words, the gas injection device 30 may allow the gaseous refrigerant separated while passing through the gas-liquid separator 31 to flow back to the compressor 10 through the second line 34, to increase the flow rate of the refrigerant circulating the refrigerant line 11.

The gas-liquid separator 31 may discharge the liquid refrigerant among the supplied refrigerant to the refrigerant line 11 connected to the fourth expansion valve 32 through a portion of the first line 33.

The fourth expansion valve 32 may expand the refrigerant supplied from the gas-liquid separator 31 through the opened portion of the first line 33 and the refrigerant line 11. In addition, the fourth expansion valve 32 may supply the expanded refrigerant to the second heat-exchanger 17 through the refrigerant line 11.

The refrigerant having passed through the second heat-exchanger 17 may be introduced into the second expansion valve 16 along the refrigerant line 11. The second expansion valve 16 may allow the refrigerant introduced through the refrigerant line 11 from the second heat-exchanger 17 to flow to the first heat-exchanger 13 without expansion.

Accordingly, the first heat-exchanger 13 may evaporate the refrigerant while heat-exchanging the refrigerant expanded in the fourth expansion valve 32 and having passed through the second heat-exchanger 17 and the second expansion valve 16 with the ambient air. The refrigerant may directly absorb the ambient air heat from the ambient air.

Then, the refrigerant having recollected the ambient air heat while passing through the first heat-exchanger 13 may be introduced into the control valve 12 along the refrigerant line 11.

The control valve 12 may allow the refrigerant introduced through the refrigerant line 11 from the first heat-exchanger 13 to flow along the refrigerant line 11 connected to the upstream end of the compressor 10.

Accordingly, the refrigerant discharged from the first heat-exchanger 13 may be introduced into the second heat-exchanger 17 along the refrigerant line 11 by the control valve 12.

The second heat-exchanger 17 may heat-exchange the refrigerant introduced from the gas injection device 30 with the refrigerant introduced from the first heat-exchanger 13.

Accordingly, the second heat-exchanger 17 may further lower the temperature of the refrigerant discharged to the first heat-exchanger 13.

The refrigerant having passed through the second heat-exchanger 17 from the first heat-exchanger 13 along the refrigerant line 11 may be introduced into the accumulator 18. Thereafter, the refrigerant may pass through the accumulator 18, to be introduced into the compressor 10.

In other words, the refrigerant having passed through the first heat-exchanger 13, and the refrigerant supplied from the gas-liquid separator 31 through the second line 34 may be introduced into the compressor 10. The introduced refrigerant may be compressed by the operation of the compressor 10.

The refrigerant compressed in the compressor 10 may pass through the vehicle interior heat-exchanger 15 along the refrigerant line 11 connected by the control valve 12, to be supplied to the first expansion valve 14.

The heat pump system may repeatedly perform the above-described processes.

As such, a heat pump system according to an embodiment may recollect the ambient air heat from the first heat-exchanger 13 while driving the vehicle together with the operation of the gas injection device 30, thereby improving the overall heating performance and efficiency of the system and vehicle.

In addition, according to the present disclosure, the heating efficiency and performance may be improved while minimizing the usage of a separate electric heater.

In addition, the gas injection device 30 can increase the flow rate of the refrigerant circulating the refrigerant line 11, thereby maximizing the heating performance.

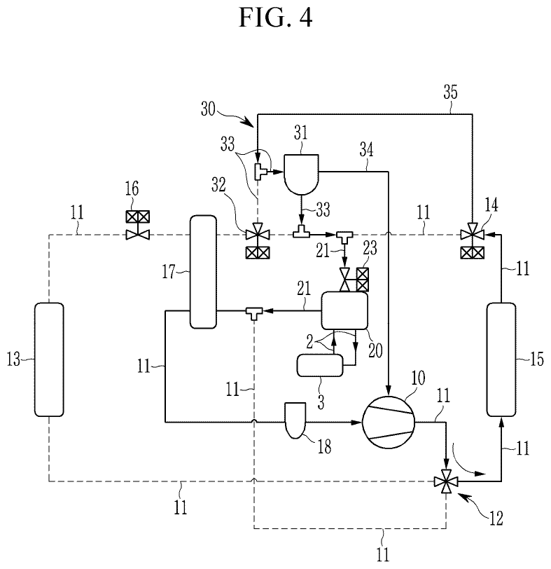

In an embodiment of the present disclosure, an operation in the third mode for recollecting the waste heat of the heating element 3 while heating the vehicle interior and in which the gas injection device 30 may be operated is described in detail below with reference to FIG. 4.

FIG. 4 is an operation diagram according to the third mode in a heat pump system for the vehicle according to an embodiment of the present disclosure.

Referring to FIG. 4, in the third mode, in order to heat the vehicle interior, the compressor 10 may be operated so that the refrigerant flows along the refrigerant line 11.

The portion of the refrigerant line 11 connecting the compressor 10, the vehicle interior heat-exchanger 15, and the first expansion valve 14 may be opened by the control valve 12.

In addition, the portion of the refrigerant line 11 connecting the first expansion valve 14 to the second end of the connection line 21 may be closed by the first expansion valve 14.

In addition, the portion of the refrigerant line 11 connecting the control valve 12 to the second end of the first line 33 via the first heat-exchanger 13, the second expansion valve 16, the second heat-exchanger 17, and the fourth expansion valve 32 may be closed by the control valve 12.

The operation of the second expansion valve 16 and the fourth expansion valve 32 may be stopped.

In addition, the portion of the refrigerant line 11 connecting the control valve 12 to the upstream end of the compressor 10 may be closed by the control valve 12.

In addition, the portion of the refrigerant line 11 connecting the second end of the first line 33 to the second end of the connection line 21 may be opened.

The connection line 21 may be opened by the third expansion valve 23.

Simultaneously, a portion of the first line 33 connecting the fourth expansion valve 32 to the second end of the third line 35 may be closed by the fourth expansion valve 32.

In addition, a portion of the first line 33 connecting the second end of the third line 35 to the gas-liquid separator 31, and a remaining first line 33 connecting the second end of the first line 33 to the gas-liquid separator 31 may be opened.

The second line 34 may be opened. In addition, the third line 35 may be opened by the first expansion valve 14.

Thus, the refrigerant discharged from the compressor 10 may be introduced into the control valve 12 along the refrigerant line 11.

The control valve 12 may allow the refrigerant introduced through the refrigerant line 11 from the compressor 10 to flow along the refrigerant line 11 connected to the vehicle interior heat-exchanger 15.

In other words, the refrigerant compressed in the compressor 10 may be supplied to the vehicle interior heat-exchanger 15 along the refrigerant line 11 connected by the control valve 12.

The vehicle interior heat-exchanger 15 may condense the introduced refrigerant through heat-exchange with the ambient air introduced into the HVAC module. The refrigerant supplied to the vehicle interior heat-exchanger 15 may increase the temperature of the ambient air introduced into the HVAC module.

Accordingly, the ambient air introduced from the outside may be converted into a high-temperature state while passing through the vehicle interior heat-exchanger 15 and then introduced into the vehicle interior, thereby implementing heating of the vehicle interior.

The refrigerant condensed in the vehicle interior heat-exchanger 15 may be introduced into the first expansion valve 14 along the refrigerant line 11.

The first expansion valve 14 may expand the refrigerant introduced through the refrigerant line 11 from the vehicle interior heat-exchanger 15, and may allow the expanded refrigerant to flow along the third line 35.

The refrigerant flowing through the third line 35 may be introduced into the gas-liquid separator 31 along the opened portion of the first line 33.

The gas-liquid separator 31 may supply the gaseous refrigerant among the refrigerant supplied from the first expansion valve 14 through the third line 35 and a portion of the first line 33 to the compressor 10 through the opened second line 34.

In other words, the gas injection device 30 may allow the gaseous refrigerant separated while passing through the gas-liquid separator 31 to flow back to the compressor 10 through the second line 34, to increase the flow rate of the refrigerant circulating the refrigerant line 11.

The gas-liquid separator 31 may discharge the liquid refrigerant among the supplied refrigerant to the refrigerant line 11 connected to the connection line 21 through a portion of the first line 33.

The refrigerant introduced into the connection line 21 from the gas-liquid separator 31 through a portion of the first line 33 and the refrigerant line 11 may be supplied to the third expansion valve 23.

The third expansion valve 23 may expand the refrigerant introduced through the connection line 21 and supply the expanded refrigerant to the chiller 20.

The refrigerant introduced into the chiller 20 may cool the coolant while being heat-exchanged with the coolant supplied from the heating element 3 through the coolant line 2.

The coolant may increase its temperature by recollecting the waste heat from the heating element 3 while cooling the heating element 3. The coolant whose temperature is increased through such an operation may be supplied to the chiller 20.

The chiller 20 may recollect the waste heat of the heating element 3 while heat-exchanging the coolant supplied from the heating element 3 through the coolant line 2 with the refrigerant.

In addition, the refrigerant having passed through the chiller 20 may be introduced into the second heat-exchanger 17 along the connection line 21 and the refrigerant line 11.

The refrigerant having passed through the second heat-exchanger 17 may be introduced into the accumulator 18. Thereafter, the refrigerant may pass through the accumulator 18, to be introduced into the compressor 10.

In other words, the refrigerant having passed through the second heat-exchanger 17 from the chiller 20, and the refrigerant supplied from the gas-liquid separator 31 through the second line 34 may be introduced into the compressor 10. The introduced refrigerant may be compressed by the operation of the compressor 10.

The refrigerant compressed in the compressor 10 may pass through the vehicle interior heat-exchanger 15 along the refrigerant line 11 connected by the control valve 12, to be supplied to the first expansion valve 14.

The heat pump system may repeatedly perform the above-described processes.

As such, a heat pump system according to an embodiment can smoothly recollect the waste heat of the heating element 3 in the chiller 20 together with the operation of the gas injection device 30, thereby improving the overall heating performance and efficiency of the system and vehicle.

In addition, according to the present disclosure, the heating efficiency and performance may be improved while minimizing the usage of a separate electric heater.

In addition, the gas injection device 30 can increase the flow rate of the refrigerant circulating the refrigerant line 11, thereby maximizing the heating performance.

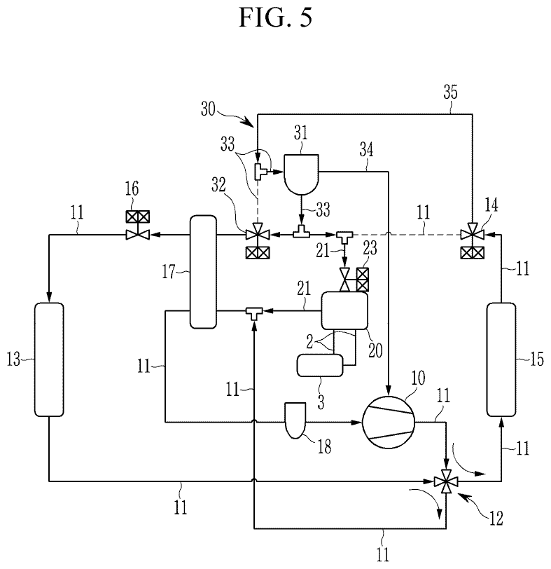

In an embodiment of the present disclosure, an operation in the fourth mode for recollecting the ambient air heat and the waste heat of the heating element 3 while heating the vehicle interior and in which the gas injection device 30 may be operated is described in detail below with reference to FIG. 5.

FIG. 5 is an operation diagram according to the fourth mode in a heat pump system for the vehicle according to an embodiment of the present disclosure.

Referring to FIG. 5, in order to heat the vehicle interior, the compressor 10 may be operated so that the refrigerant flows along the refrigerant line 11.

The portion of the refrigerant line 11 connecting the compressor 10, the vehicle interior heat-exchanger 15, and the first expansion valve 14 may be opened by the control valve 12.

In addition, the portion of the refrigerant line 11 connecting the first expansion valve 14 to the second end of the connection line 21 may be closed by the first expansion valve 14.

The portion of the refrigerant line 11 connecting the second end of the first line 33 to the fourth expansion valve 32 may be opened by the fourth expansion valve 32.

The portion of the refrigerant line 11 connecting the fourth expansion valve 32 to the second heat-exchanger 17, the second expansion valve 16, the first heat-exchanger 13, and the control valve 12 may be opened by the control valve 12 and the second expansion valve 16.

In addition, the portion of the refrigerant line 11 connecting the second end of the first line 33 to the second end of the connection line 21 may be opened.

In addition, the portion of the refrigerant line 11 connecting the control valve 12 to the upstream end of the compressor 10 may be opened by the control valve 12.

The connection line 21 may be opened by the third expansion valve 23.

A portion of the first line 33 connecting the fourth expansion valve 32 to the second end of the third line 35 may be closed by the fourth expansion valve 32.

In addition, a portion of the first line 33 connecting the second end of the third line 35 to the gas-liquid separator 31, and a remaining first line 33 connecting the second end of the first line 33 to the gas-liquid separator 31 may be opened.

The second line 34 may be opened. In addition, the third line 35 may be opened by the first expansion valve 14.

Thus, the refrigerant discharged from the compressor 10 may be introduced into the control valve 12 along the refrigerant line 11.

The control valve 12 may allow the refrigerant introduced through the refrigerant line 11 from the compressor 10 to flow along the refrigerant line 11 connected to the vehicle interior heat-exchanger 15.

In other words, the refrigerant compressed in the compressor 10 may be supplied to the vehicle interior heat-exchanger 15 along the refrigerant line 11 connected by the control valve 12.

The vehicle interior heat-exchanger 15 may condense the introduced refrigerant through heat-exchange with the ambient air introduced into the HVAC module. The refrigerant supplied to the vehicle interior heat-exchanger 15 may increase the temperature of the ambient air introduced into the HVAC module.

Accordingly, the ambient air introduced from the outside may be converted into a high-temperature state while passing through the vehicle interior heat-exchanger 15 and then introduced into the vehicle interior, thereby implementing heating of the vehicle interior.

The refrigerant condensed in the vehicle interior heat-exchanger 15 may be introduced into the first expansion valve 14 along the refrigerant line 11.

The first expansion valve 14 may expand the refrigerant introduced through the refrigerant line 11 from the vehicle interior heat-exchanger 15 and may allow the expanded refrigerant to flow along the third line 35.

The refrigerant flowing through the third line 35 may be introduced into the gas-liquid separator 31 along the opened portion of the first line 33.

The gas-liquid separator 31 may supply the gaseous refrigerant among the refrigerant supplied from the first expansion valve 14 through the third line 35 and a portion of the first line 33 to the compressor 10 through the opened second line 34.

In other words, the gas injection device 30 may allow the gaseous refrigerant separated while passing through the gas-liquid separator 31 to flow back to the compressor 10 through the second line 34, to increase the flow rate of the refrigerant circulating the refrigerant line 11.

The gas-liquid separator 31 may discharge the liquid refrigerant among the supplied refrigerant through a portion of the first line 33.

A partial refrigerant among the refrigerant discharged through the first line 33 may flow through the refrigerant line 11 connected to the fourth expansion valve 32.

The fourth expansion valve 32 may expand the partial refrigerant supplied from the gas-liquid separator 31 through the opened portion of the first line 33 and the refrigerant line 11.

In addition, the fourth expansion valve 32 may supply the expanded refrigerant to the second heat-exchanger 17 through the refrigerant line 11.

The refrigerant having passed through the second heat-exchanger 17 may be introduced into the second expansion valve 16 along the refrigerant line 11. The second expansion valve 16 may allow the refrigerant introduced through the refrigerant line 11 from the second heat-exchanger 17 to flow to the first heat-exchanger 13 without expansion.

Accordingly, the first heat-exchanger 13 may evaporate the refrigerant while heat-exchanging the refrigerant expanded in the fourth expansion valve 32 and having passed through the second heat-exchanger 17 and the second expansion valve 16 with the ambient air. The refrigerant may directly absorb the ambient air heat from the ambient air.

The refrigerant having recollected the ambient air heat while passing through the first heat-exchanger 13 may be introduced into the control valve 12 along the refrigerant line 11.

The control valve 12 may allow the refrigerant introduced through the refrigerant line 11 from the first heat-exchanger 13 to flow along the refrigerant line 11 connected to the upstream end of the compressor 10.

Accordingly, the refrigerant discharged from the first heat-exchanger 13 may be introduced into the second heat-exchanger 17 along the refrigerant line 11 by the control valve 12.

A remaining refrigerant among the refrigerant discharged through the first line 33 may be discharged to the refrigerant line 11 connected to the connection line 21.

In other words, the refrigerant introduced into the connection line 21 from the gas-liquid separator 31 through a portion of the first line 33 and the refrigerant line 11 may be supplied to the third expansion valve 23.

The third expansion valve 23 may expand the refrigerant introduced through the connection line 21 and supply the expanded refrigerant to the chiller 20.

The refrigerant introduced into the chiller 20 may cool the coolant while being heat-exchanged with the coolant supplied from the heating element 3 through the coolant line 2.

The coolant may increase its temperature by recollecting the waste heat from the heating element 3 while cooling the heating element 3. The coolant whose temperature is increased through such an operation may be supplied to the chiller 20.

The chiller 20 may recollect the waste heat of the heating element 3 while heat-exchanging the coolant supplied from the heating element 3 through the coolant line 2 with the refrigerant.

In addition, the refrigerant having passed through the chiller 20 may be introduced into the second heat-exchanger 17 along the connection line 21 and the refrigerant line 11.

Accordingly, the refrigerant having passed through the chiller 20 may be introduced into the second heat-exchanger 17 together with the refrigerant having passed through the first heat-exchanger 13.

The second heat-exchanger 17 may heat-exchange the refrigerant introduced from the gas injection device 30, with the refrigerant introduced together from the first heat-exchanger 13 and the chiller 20.

Accordingly, the second heat-exchanger 17 may further lower the temperature of the refrigerant discharged to the first heat-exchanger 13.

The refrigerant having passed through the second heat-exchanger 17 from the first heat-exchanger 13 and the chiller 20 along the refrigerant line 11 may be introduced into the accumulator 18. Thereafter, the refrigerant may pass through the accumulator 18, to be introduced into the compressor 10.

In other words, the refrigerant having passed through the second heat-exchanger 17 from the first heat-exchanger 13 and the chiller 20, and the refrigerant supplied from the gas-liquid separator 31 through the second line 34 may be introduced into the compressor 10. The introduced refrigerant may be compressed by the operation of the compressor 10.

The refrigerant compressed in the compressor 10 may pass through the vehicle interior heat-exchanger 15 along the refrigerant line 11 connected by the control valve 12, to be supplied to the first expansion valve 14.

The heat pump system may repeatedly perform the above-described processes.

As such, a heat pump system according to an embodiment may recollect the ambient air heat from the first heat-exchanger 13 while driving the vehicle together with the operation of the gas injection device 30, and smoothly recollect the waste heat of the heating element 3 in the chiller 20, thereby improving the overall heating performance and efficiency of the system and vehicle.

In addition, according to the present disclosure, the heating efficiency and performance may be improved while minimizing the usage of a separate electric heater.

In addition, the gas injection device 30 can increase the flow rate of the refrigerant circulating the refrigerant line 11, thereby maximizing the heating performance.

Therefore, as described above, when a heat pump system for a vehicle according to an embodiment of the present disclosure is applied, the vehicle interior may be cooled or heated by using the single vehicle interior heat-exchanger 15 into which the high-temperature refrigerant or the low-temperature refrigerant is selectively introduced, thereby reducing the number of system components.

In addition, according to the present disclosure, by employing the gas injection device 30 selectively operating in at least one mode selected for air-conditioning of the vehicle interior, the flow rate of the refrigerant can be increased, thereby improving the cooling and heating performance of the system and vehicle.

In addition, according to the present disclosure, the performance of the system can be maximized by using the gas injection device 30 while minimizing the number of components, so that streamlining and simplification of the system may be achieved.

In addition, according to the present disclosure, by using the single chiller 20 where the coolant and the refrigerant are heat-exchanged with each other, the temperature of the electrical component included in the heating element 3 and the battery module can be efficiently adjusted, in at least one mode selectively, and the waste heat of the heating element 3 can be smoothly recollected.

In addition, according to the present disclosure, by efficiently adjusting the temperature of the battery module included in the heating element 3, the optimal performance of the battery module may be achieved, and through efficient management of the battery module, the overall travel distance of the vehicle may be increased.

In addition, according to the present disclosure, through streamlining of an entire system, it is possible to reduce manufacturing cost and weight and improve space utilization of the vehicle.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

### DESCRIPTION OF SYMBOLS

2: coolant line
3: heating element
10: compressor
11: refrigerant line
12: control valve
13: first heat-exchanger
14: first expansion valve
15: vehicle interior heat-exchanger
16: second expansion valve
17: second heat-exchanger
18: accumulator
20: chiller
21: connection line
23: third expansion valve
30: gas injection device
31: gas-liquid separator
32: fourth expansion valve
33: first line
34: second line
35: third line

What is claimed is:

1. A heat pump system for a vehicle, the heat pump system comprising:
a compressor configured to compress a refrigerant;
a control valve connected to the compressor through a refrigerant line;
a first heat-exchanger connected to the control valve through the refrigerant line, and configured to selectively condense or evaporate the refrigerant;
a first expansion valve connected to the first heat-exchanger through the refrigerant line;
a vehicle interior heat-exchanger connected to the first expansion valve and the control valve through the refrigerant line, and configured to selectively condense or evaporate the refrigerant;
a second expansion valve provided on the refrigerant line between the first heat-exchanger and the first expansion valve;
a second heat-exchanger respectively connected to the refrigerant line connecting the first expansion valve and the second expansion valve, and the refrigerant line connecting the control valve and the compressor at an upstream end of the compressor;
a connection line having a first end connected to the refrigerant line at the upstream end of the compressor, and a second end connected to the refrigerant line between the first expansion valve and the second expansion valve;
a chiller provided on the connection line, and configured to adjust a temperature of a coolant by heat-exchanging the refrigerant introduced through the connection line with the coolant;
a third expansion valve provided on the connection line at an upstream end of the chiller; and
a gas injection device provided on the refrigerant line between the first expansion valve and the second heat-exchanger, and configured to selectively expand the refrigerant supplied from the second heat-exchanger and allow expanded refrigerant to flow or allow the expanded refrigerant supplied from the vehicle interior heat-exchanger through the first expansion valve to flow, and to selectively supply a partial refrigerant among supplied refrigerant to the compressor to increase a flow rate of the refrigerant circulating through the refrigerant line,
wherein the flow rate of the refrigerant is controlled based on at least one mode of the heat pump system for adjusting a temperature of a vehicle interior or for adjusting a temperature of a heating element.

2. The heat pump system of claim 1, wherein the gas injection device comprises:
a gas-liquid separator configured to separate the refrigerant into a gaseous refrigerant and a liquid refrigerant and configured to selectively discharge the gaseous refrigerant and the liquid refrigerant;
a fourth expansion valve provided on the refrigerant line between the second heat-exchanger and a second end of the connection line;
a first line having a first end connected to the fourth expansion valve and a second end connected to the refrigerant line between the fourth expansion valve and the second end of the connection line, wherein the gas-liquid separator is provided on the first line;
a second line having a first end connected to the gas-liquid separator and a second end connected to the compressor; and
a third line having a first end connected to the first expansion valve and a second end connected to the first line between the fourth expansion valve and the gas-liquid separator.

3. The heat pump system of claim 2, wherein the gas-liquid separator is operated when the fourth expansion valve or the first expansion valve expands the refrigerant and supplies expanded refrigerant while cooling or heating the vehicle interior, and configured to supply the gaseous refrigerant among supplied refrigerant to the compressor through the second line to increase the flow rate of the refrigerant circulating the refrigerant line.

4. The heat pump system of claim 2, wherein, when heating the vehicle interior, the third line is opened by the first expansion valve to supply the refrigerant from the vehicle interior heat-exchanger to the gas-liquid separator.

5. The heat pump system of claim 2, wherein the at least one mode comprises:
a first mode, in which the gas injection device is operated, for cooling the vehicle interior;
a second mode, in which the gas injection device is operated, for recollecting ambient air heat while heating the vehicle interior;
a third mode, in which the gas injection device is operated, for recollecting a waste heat of the heating element while heating the vehicle interior; and
a fourth mode, in which the gas injection device is operated, for recollecting the ambient air heat and the waste heat of the heating element while heating the vehicle interior.

6. The heat pump system of claim 5, wherein, in the first mode:
a portion of the refrigerant line connecting the compressor, the first heat-exchanger, the second heat-exchanger, and the fourth expansion valve is configured to be opened by the control valve and the second expansion valve;
a portion of the refrigerant line connecting the fourth expansion valve and a second end of the first line is configured to be closed by the fourth expansion valve;
a portion of the refrigerant line connecting the second end of the first line to the first expansion valve, the vehicle interior heat-exchanger, and the control valve is configured to be opened by the first expansion valve;
a portion of the refrigerant line connecting the control valve to the upstream end of the compressor is configured to be opened by the control valve;
the first line is configured to be opened by the fourth expansion valve;
the second line is configured to be opened;
the third line is configured to be closed by the first expansion valve;
the first expansion valve is configured to expand the refrigerant introduced from the gas-liquid separator through the first line and the refrigerant line and configured to supply expanded refrigerant to the vehicle interior heat-exchanger;
the second expansion valve is configured to allow the refrigerant introduced through the refrigerant line from the first heat-exchanger to flow to the second heat-exchanger without expansion;
the fourth expansion valve is configured to expand the refrigerant supplied from the second heat-exchanger through the refrigerant line, and is configured to supply expanded refrigerant to the gas-liquid separator through the first line; and
the gas-liquid separator is configured to supply the gaseous refrigerant among supplied refrigerant to the compressor through the opened second line, and configured to discharge the liquid refrigerant to the first expansion valve through the first line and the refrigerant line.

7. The heat pump system of claim 6, wherein the control valve is configured to:
allow the refrigerant introduced through the refrigerant line from the compressor to flow along the refrigerant line connected to the first heat-exchanger; and
allow the refrigerant introduced through the refrigerant line from the vehicle interior heat-exchanger to flow along the refrigerant line connected to the upstream end of the compressor.

8. The heat pump system of claim 6, wherein, when cooling of the heating element is required in the first mode:
the connection line is configured to be opened by the third expansion valve; and
the third expansion valve is configured to expand the refrigerant introduced through the connection line and supply expanded refrigerant to the chiller.

9. The heat pump system of claim 5, wherein, in the second mode:
a portion of the refrigerant line connecting the compressor, the vehicle interior heat-exchanger, and the first expansion valve is configured to be opened by the control valve;
a portion of the refrigerant line connecting the first expansion valve to a second end of the first line is configured to be closed by the first expansion valve;
a portion of the refrigerant line connecting the second end of the first line to the fourth expansion valve is configured to be opened by the fourth expansion valve;
a portion of the refrigerant line connecting the fourth expansion valve to the second heat-exchanger, the second expansion valve, the first heat-exchanger, and the control valve is configured to be opened by the control valve and the second expansion valve;
a portion of the refrigerant line connecting the control valve to the upstream end of the compressor is configured to be opened by the control valve;
the connection line is configured to be closed by the third expansion valve;
a portion of the first line connecting the fourth expansion valve to a second end of the third line is configured to be closed by the fourth expansion valve;
a portion of the first line connecting the second end of the third line to the gas-liquid separator, and a remaining first line connecting the second end of the first line to the gas-liquid separator are configured to be opened;
the second line is configured to be opened;
the third line is configured to be opened by the first expansion valve;
the first expansion valve is configured to expand the refrigerant introduced through the refrigerant line from the vehicle interior heat-exchanger and configured to allow expanded refrigerant to flow along the third line;
the second expansion valve is configured to allow the refrigerant introduced through the refrigerant line from the second heat-exchanger to flow to the first heat-exchanger without expansion;
the third expansion valve is configured to stop operating;
the fourth expansion valve is configured to expand the refrigerant supplied from the gas-liquid separator through the opened portion of the first line and the refrigerant line, and configured to supply expanded refrigerant to the second heat-exchanger through the refrigerant line; and
the gas-liquid separator is configured to supply the gaseous refrigerant among supplied refrigerant to the compressor through the opened second line, and configured to discharge the liquid refrigerant to the fourth expansion valve through a portion of the first line and the refrigerant line.

10. The heat pump system of claim 9, wherein the control valve is configured to:
allow the refrigerant introduced through the refrigerant line from the compressor to flow along the refrigerant line connected to the vehicle interior heat-exchanger; and
allow the refrigerant introduced through the refrigerant line from the first heat-exchanger to flow along the refrigerant line connected to the upstream end of the compressor.

11. The heat pump system of claim 5, wherein, in the third mode:
a portion of the refrigerant line connecting the compressor, the vehicle interior heat-exchanger, and the first expansion valve is configured to be opened by the control valve;
a portion of the refrigerant line connecting the first expansion valve to the second end of the connection line is configured to be closed by the first expansion valve;
a portion of the refrigerant line connecting the control valve to a second end of the first line via the first heat-exchanger, the second expansion valve, the second heat-exchanger, and the fourth expansion valve is configured to be closed by the control valve;
a portion of the refrigerant line connecting the control valve to the upstream end of the compressor is configured to be closed by the control valve;
a portion of the refrigerant line connecting the second end of the first line to the second end of the connection line is configured to be opened;
the connection line is configured to be opened by the third expansion valve;
a portion of the first line connecting the fourth expansion valve to a second end of the third line is configured to be closed by the fourth expansion valve;
a portion of the first line connecting the second end of the third line to the gas-liquid separator, and a remaining first line connecting the second end of the first line to the gas-liquid separator are configured to be opened;
the second line is configured to be opened;
the third line is configured to be opened by the first expansion valve;
the first expansion valve is configured to expand the refrigerant introduced through the refrigerant line from the vehicle interior heat-exchanger and configured to allow expanded refrigerant to flow along the third line;
the second expansion valve and the fourth expansion valve are configured to stop operating;
the third expansion valve is configured to expand the refrigerant introduced through the connection line and configured to supply expanded refrigerant to the chiller; and
the gas-liquid separator is configured to supply the gaseous refrigerant among supplied refrigerant to the compressor through the opened second line, and configured to discharge the liquid refrigerant to the third expansion valve through a portion of the first line, a portion of the refrigerant line, and the connection line.

12. The heat pump system of claim 11, wherein the control valve is configured to allow the refrigerant introduced through the refrigerant line from the compressor to flow along the refrigerant line connected to the vehicle interior heat-exchanger.

13. The heat pump system of claim 5, wherein, in the fourth mode:
a portion of the refrigerant line connecting the compressor, the vehicle interior heat-exchanger, and the first expansion valve is configured to be opened by the control valve;
a portion of the refrigerant line connecting the first expansion valve to the second end of the connection line is configured to be closed by the first expansion valve;
a portion of the refrigerant line connecting a second end of the first line to the fourth expansion valve is configured to be opened by the fourth expansion valve;
a portion of the refrigerant line connecting the fourth expansion valve to the second heat-exchanger, the second expansion valve, the first heat-exchanger, and the control valve is configured to be opened by the control valve and the second expansion valve;
a portion of the refrigerant line connecting the second end of a first line to the second end of the connection line is configured to be opened;
a portion of the refrigerant line connecting the control valve to the upstream end of the compressor is opened by the control valve;
a portion of the refrigerant line connecting the second end of the first line to the second end of the connection line is configured to be opened;
the connection line is configured to be opened by the third expansion valve;
a portion of the first line connecting the fourth expansion valve to a second end of the third line is configured to be closed by the fourth expansion valve;
a portion of the first line connecting the second end of the third line to the gas-liquid separator, and a remaining first line connecting the second end of the first line to the gas-liquid separator are configured to be opened;
the second line is configured to be opened;
the third line is configured to be opened by the first expansion valve;
the first expansion valve is configured to expand the refrigerant introduced through the refrigerant line from the vehicle interior heat-exchanger and configured to allow expanded refrigerant to flow along the third line;
the second expansion valve is configured to allow the refrigerant introduced through the refrigerant line from the second heat-exchanger to flow to the first heat-exchanger without expansion;
the third expansion valve is configured to expand the refrigerant introduced through the connection line and configured to supply expanded refrigerant to the chiller;
the fourth expansion valve is configured to expand the refrigerant supplied from the gas-liquid separator through the opened portion of the first line and the refrigerant line, and configured to supply expanded refrigerant to the second heat-exchanger through the refrigerant line; and
the gas-liquid separator is configured to supply the gaseous refrigerant among supplied refrigerant to the compressor through the opened second line, and configured to discharge the liquid refrigerant to the third expansion valve and the fourth expansion valve, through a portion of the first line, a portion of the refrigerant line, and the connection line.

14. The heat pump system of claim 13, wherein the control valve is configured to:
allow the refrigerant introduced through the refrigerant line from the compressor to flow along the refrigerant line connected to the vehicle interior heat-exchanger; and
allow the refrigerant introduced through the refrigerant line from the first heat-exchanger to flow along the refrigerant line connected to the upstream end of the compressor.

15. The heat pump system of claim 5, wherein the first heat-exchanger is configured to:
condense the refrigerant supplied in the first mode; and
evaporate the refrigerant supplied in the second mode and the fourth mode.

16. The heat pump system of claim 5, wherein the vehicle interior heat-exchanger is configured to:
evaporate the refrigerant supplied in the first mode; and
condense the refrigerant supplied in the second mode, the third mode, and the fourth mode.

17. The heat pump system of claim 2, wherein:
the first expansion valve and the fourth expansion valve are 3-way electronic expansion valves selectively operated in the at least one mode and configured to selectively expand the refrigerant while controlling a flow rate of the supplied refrigerant; and
the second expansion valve and the third expansion valve are 2-way electronic expansion valves selectively operated in the at least one mode and configured to selectively expand the refrigerant while controlling the flow rate of the supplied refrigerant.

18. The heat pump system of claim 1, wherein the first heat-exchanger and the vehicle interior heat-exchanger are configured to selectively condense or evaporate the refrigerant introduced in the at least one mode.

19. The heat pump system of claim 1, wherein the second heat-exchanger is configured to heat-exchange the refrigerant introduced from at least one of the first heat-exchanger or the gas injection device, and the refrigerant introduced from at least one of the first heat-exchanger or the vehicle interior heat-exchanger or the chiller, with each other.

20. The heat pump system of claim 1, wherein:
the chiller is connected to the heating element through a coolant line circulating a coolant; and
the coolant line is configured to be opened to connect the heating element and the chiller, when cooling of the heating element is required, or when the waste heat is to be recollected from the heating element.
